(19) United States
(12) Patent Application Publication
(10) Pub. No.: US 2017/0032651 A1
(43) Pub. Date: Feb. 2, 2017

(54) Weather Alert System

(71) Applicant: Christine Eubanks, Sapulpa, OK (US)

(72) Inventor: Christine Eubanks, Sapulpa, OK (US)

(21) Appl. No.: 15/220,894

(22) Filed: Jul. 27, 2016

Related U.S. Application Data
(60) Provisional application No. 62/197,866, filed on Jul. 28, 2015.

(51) Int. Cl. G08B 21/10

(52) U.S. Cl. CPC G08B 21/10

(57) ABSTRACT

A weather alert system for notifying a user of an extreme weather event. The weather alert system includes a base unit that can be positioned within a user's home or office. The base unit is configured to receive a signal or communication from a weather service regarding extreme weather events in the local area such as tornados, hurricanes, and snowstorms, among others. The base unit includes a speaker system that produces a tone or alarm when a communication is received regarding an extreme weather event. Further, the base unit includes a transmitter for sending an alert to one or more mobile electronic in order to receive weather information in the location of the base unit. The base unit may be used to provide an alert for only a single type of weather event, such as a tornado.

### CROSS REFERENCE TO RELATED APPLICATION

This application claims the benefit of U.S. Provisional Application No. 62/197,866 filed on Jul. 28, 2015. The above identified patent application is herein incorporated by reference in its entirety to provide continuity of disclosure.

### BACKGROUND OF THE INVENTION

### Field of the Invention

The present invention relates to alert systems. More specifically, the present invention provides a weather alert system for use in notifying a user of extreme weather events occurring in his or her area.

Extreme weather events, such as tornadoes, hurricanes, tsunamis, and snowstorms, among others are dangerous and require people to take proper safety precautions in order to minimize property damage and injury. The public is often warned of extreme weather events through the radio, television, and newspapers. However, these channels of communication may be insufficient to warn many members of the public. Those who do not regularly watch television as well as those who are hard of hearing or those who tend to sleep through and miss the traditional warnings entirely and may fail to take proper safety precautions as a result. This is particularly true for those who live in rural or remote areas with limited access to news. It is important that the information is distributed quickly so that the public receives the information in a timely manner. This is because storms may develop and move rapidly, giving people little time to make preparations. Thus, a device dedicated to warning the user of an extreme weather condition is desired.

Devices have been disclosed in the known art that relate to weather alert systems. These include devices that have been patented and published in patent application publications. These devices generally relate to weather alert devices, specifically for providing tornado warnings, such as U.S. Published Patent Application Number 2014/0055272, U.S. Pat. No. 3,810,137, and U.S. Pat. No. 4,039,957.

These devices in the known art have several known drawbacks. These devices fail to provide a base unit adapted to receive a communication from a weather service and then transmit an alert to one or more mobile electronic devices, wherein the base unit further includes a speaker system adapted to provide an audible alert for the user. Further, the devices in the known art fail to include a GPS unit for determining the location of the base unit in order to provide local weather information regardless of the location of the base unit. Additionally, these devices fail to reach the hard to reach rural areas, the hard of hearing, as well as those who tend to sleep through traditional alarms.

In light of the devices disclosed in the known art, it is submitted that the present invention substantially diverges in design elements from the known art and consequently it is clear that there is a need in the art for an improvement to existing weather alert systems. In this regard the instant invention substantially fulfills these needs.

### SUMMARY OF THE INVENTION

In view of the foregoing disadvantages inherent in the known types of weather alert systems now present in the known art, the present invention provides a new weather alert system wherein the same can be utilized for providing convenience for the user when notifying a user of an extreme weather event in the local area.

It is therefore an object of the present invention to provide a new and improved weather alert system for warning a user of an extreme weather event. The weather alert system comprises a base unit adapted to receive a signal or communication from a weather service regarding local, severe weather information and transmit an alert to one or more mobile electronic devices regarding an extreme weather event in the area. The base unit comprises a control circuit having a microprocessor, a transmitter, a receiver, a GPS unit, and a speaker system. The base unit further provides an audible alert in the event of an extreme weather event.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of the operation of the weather alert system.

FIG. 2 shows a perspective view of an embodiment of the weather alert system.

FIG. 3 shows a schematic diagram of the weather alert system.

### DETAILED DESCRIPTION OF THE INVENTION

Reference is made herein to the attached drawings. Like reference numerals are used throughout the drawings to depict like or similar elements of the weather alert system. For the purposes of presenting a brief and clear description of the present invention, the preferred embodiment will be discussed as used for notifying a user about an extreme weather event. The figures are intended for representative purposes only and should not be considered to be limiting in any respect.

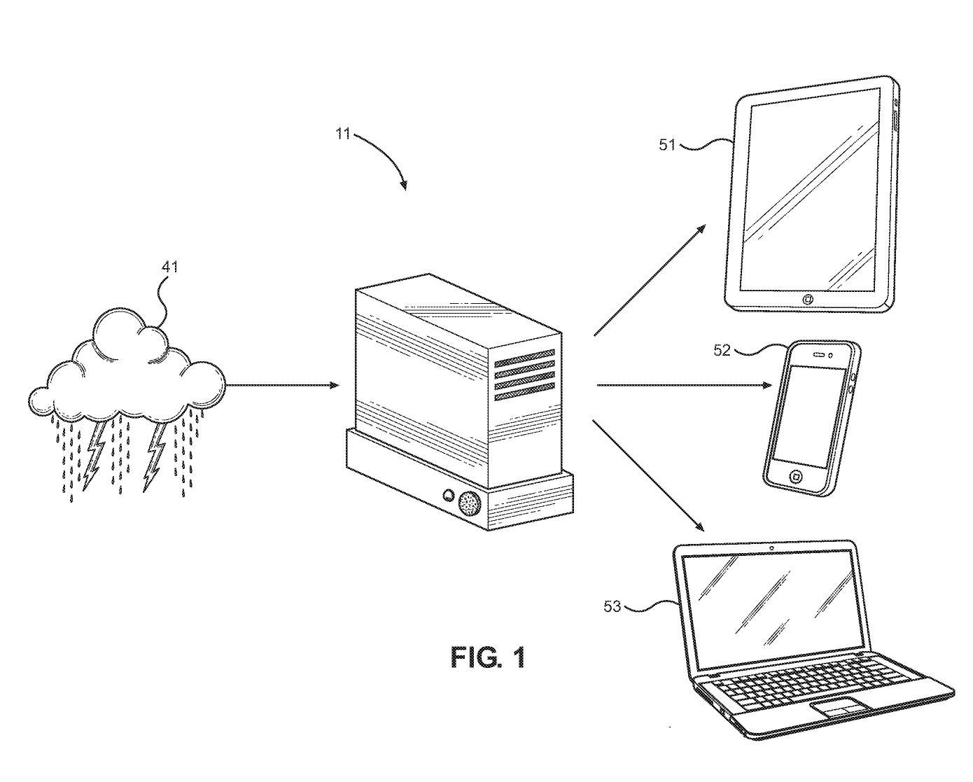

Referring now to FIG. 1, there is shown a diagram of the operation of the weather alert system. The weather alert system 11 is adapted to receive weather information from a weather service or weather station and transmit an alert to the user's mobile devices. In operation, a weather service or weather station 41 transmits a signal or communication to the weather alert system 11. The weather alert system 11 is adapted to wirelessly communicate with the weather service so as to receive weather information for the local area, particularly regarding extreme weather events such as hurricanes, tornadoes, and snowstorms, among others. Any of various forms of wireless communication may be used.

Upon receipt of a communication regarding an extreme weather event, the weather alert system 11 may produce an audible alert and may wirelessly send an alert to one or more mobile electronic devices. Thus, the weather alert system 11 is adapted to transmit an alert to one or more of the user's mobile electronic devices, such as a tablet 51, cell phone 52, or a laptop 53, among others. The user can pair or link the mobile electronic device with the weather alert system 11 so that the mobile electronic device can receive wireless communications from the weather alert system 11. The alert preferably notifies the user of the local weather event. The alert may include a tone, alarm, vibration, or a written message, among other types of notifications.

Referring now to FIG. 2, there is shown an embodiment of the weather alert system. The weather alert system 11 comprises a base unit 12 having a housing 14 adapted to rest on a support surface, such as a table, countertop, or other similar location. Alternatively, the base unit 12 can be mounted to a wall or the like so that the weather alert system 11 is disposed in a fixed location within a user's home or other area.

The base unit 12 encloses a control circuit that receives signals from a weather service and that transmits an alert to the user's mobile electronic devices. The housing 12 includes a speaker system 13 thereon for producing an audible alert. When the weather alert service sends a signal about an extreme weather event to the weather alert system 11, the weather alert system 11 produces a tone, alarm, or recorded message to tell users in the nearby area about the weather event. The audible alert is preferably sufficiently loud so as to wake the users from sleep or so as to audible to those standing outside of the home, such as in the yard or on a porch. This helps to ensure that users are immediately notified of the extreme weather event.

Further, the housing 12 includes an indicator light 16 for indicating if the weather alert system 11 is operating properly. The indicator light 16 will illuminate if the weather alert system 11 is receiving electricity and is wirelessly communicating with a weather service and mobile devices. The indicator light 16 will not illuminate if there is no power supplied to the system 11 or if the wireless communication is not functioning properly. The indicator light 16 is preferably an LED so as to provide high brightness with limited power consumption. In some embodiments, a control 15 is provided wherein the user can actuate the control 15 in order to determine if the system is operating properly. If the system is operating properly, the indicator light 16 will illuminate or flash.

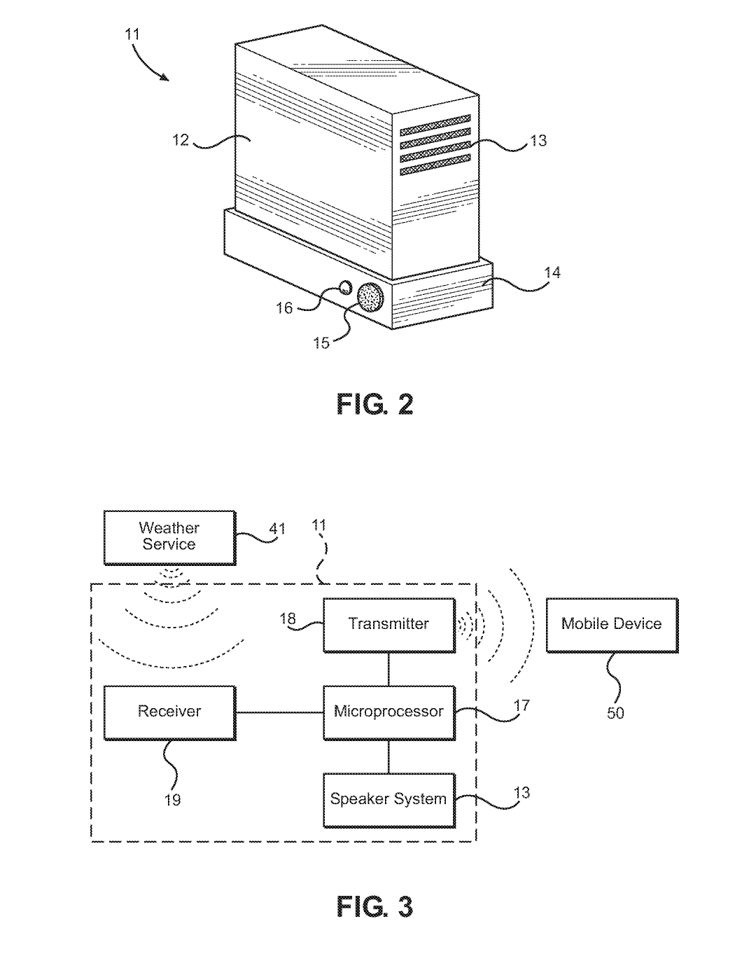

Referring now to FIG. 3, there is shown a schematic diagram of the weather alert system. The weather alert system 11 comprises a microprocessor 17, a receiver 19 for receiving signals from a weather alert service, a transmitter 18 for sending signals to one or more mobile devices, a GPS unit 20, and a speaker system 13. The receiver 19 and transmitter 18 are adapted to send and receive signals using any of various modes of wireless communication. In some embodiments, the receiver 19 and transmitter 18 are combined in one wireless transceiver. The microprocessor 17 coordinates operation of the receiver 19 and transmitter 18 and further analyzes the signals received from the weather alert service to determine the nature and type of weather event being reported.

The GPS unit 20 is used to determine the location of the base unit of the weather alert system 11. The weather alert system 11 is adapted to communicate with a local weather service 41 or weather station. The GPS unit 20 is used to determine the base unit's location. Weather information regarding the location of the base unit is then transmitted to the base unit as determined by the GPS unit 20. This helps to ensure that the base unit is receiving weather information regarding local weather events. Further, if the base unit is moved to a different location, the weather alerts will be automatically updated to that of the new location. In alternate embodiments, the base unit is adapted to communicate with a dedicated weather service or weather station regardless of the location thereof.

The receiver 19 is adapted to receive signals or communications from a local weather service 41. In some embodiments, the weather alert system 11 is adapted to only provide an alert as result of a specific type of event, such as a tornado. Thus, the weather alert system 11 receives signals from a weather service 41, and if one such signal is in regards to a tornado, the weather alert system 11 is adapted to produce an audible alert or tone via the speaker system 13 thereon. The weather alert system 11 then transmits a signal to one or more mobile devices 50 that are in wireless communication with the base unit.

The signal may simply notify the user that an extreme weather event is occurring. However, in alternate embodiments, the message may include additional details such as the severity of the event, the location, the time the event is due to occur, among various other information. It is not desired to limit the specific signal or message transmitted via the base unit to a mobile device 50.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A weather alert system, comprising:
a base unit having a control circuit;
wherein the control circuit comprises a microprocessor, a receiver adapted to receive a signal from a weather service, a transmitter adapted to transmit an alert to a mobile device;
wherein the control circuit further comprising a speaker system adapted to produce an audible alert when said signal from said weather service is received.

2) The weather alert system of claim 1, wherein the control circuit further comprises a GPS unit adapted to determine the location of the base unit.

3) The weather alert system of claim 2, wherein the base unit receives a signal encoding weather information for the specific location of the base unit as determined by the GPS unit of the base unit.

4) The weather alert system of claim 1, wherein the base unit is adapted to wirelessly communicate with one or more mobile electronic devices so as to provide the alert to the one or more mobile electronic devices.

5) The weather alert system of claim 1, wherein the base unit is adapted to communicate the alert regarding a single type of weather event.

6) The weather alert system of claim 1, wherein the alert comprises a message that describes the weather event.

7) A method for receiving weather alerts, comprising the steps of:
providing a base unit having a microprocessor, a receiver, and a transmitter;
receiving a signal from a weather service regarding a weather event;
transmitting an alert to a user regarding the weather event.

8) The method for receiving weather alerts of claim 7, wherein the step of transmitting an alert to a user regarding the weather event comprises the step of the base unit producing an audible alert.

9) The method for receiving weather alerts of claim 7, wherein the step of transmitting an alert to a user regarding the weather event comprises the step of transmitting a signal to a mobile electronic device of the user.
